(19) United States
(12) Patent Application Publication
(10) Pub. No.: US 2018/0088498 A1
(43) Pub. Date: Mar. 29, 2018

(54) IMAGE FORMING APPARATUS

(71) Applicant: FUJI XEROX CO., LTD., Tokyo (JP)

(72) Inventors: Shin HONDA, Kanagawa (JP); Hidekazu AMAMOTO, Kanagawa (JP); Hiroki ANDO, Kanagawa (JP); Takashi AKAIKE, Kanagawa (JP); Yuichi SONO, Kanagawa (JP); Satoru ISHII, Kanagawa (JP); Yuki TERAKADO, Kanagawa (JP)

(73) Assignee: FUJI XEROX CO., LTD., Tokyo (JP)

(21) Appl. No.: 15/585,883

(22) Filed: May 3, 2017

(30) Foreign Application Priority Data
Sep. 29, 2016 (JP) 2016-192122

(51) Int. Cl. G03G 15/00

(52) U.S. Cl. CPC G03G 15/2017; G03G 2215/2074; G03G 15/206; G03G 15/2053

(57) ABSTRACT

An image forming apparatus includes: a transferring unit that transfers an image carried on an image carrier to a medium;
a fixing unit that is disposed in an upper portion of a main body of the image forming apparatus, that includes a heat source, and that fixes the image transferred to the medium by heat;
a discharge port that is disposed below the fixing unit, the medium having the fixed image being discharged to the discharge port; and
a discharge unit that is disposed at a position where the discharge unit overlaps the fixing unit when viewed from above and below the fixing unit, that includes an open portion formed between the discharge unit and the discharge port, and that accommodates the medium having passed through the discharge port.

### CROSS-REFERENCE TO RELATED APPLICATIONS

This application is based on and claims priority under 35 USC 119 from Japanese Patent Application No. 2016-192122 filed Sep. 29, 2016.

### BACKGROUND

### Technical Field

The present invention relates to an image forming apparatus.

### SUMMARY

According to an aspect of the invention, an image forming apparatus includes:

a transferring unit that transfers an image carried on an image carrier to a medium;

a fixing unit that is disposed in an upper portion of a main body of the image forming apparatus, that includes a heat source, and that fixes the image transferred to the medium by heat;

a discharge port that is disposed below the fixing unit, the medium having the fixed image being discharged to the discharge port; and

a discharge unit that is disposed at a position where the discharge unit overlaps the fixing unit when viewed from above and below the fixing unit, that includes an open portion formed between the discharge unit and the discharge port, and that accommodates the medium having passed through the discharge port.

### BRIEF DESCRIPTION OF THE DRAWINGS

Exemplary embodiments of the present invention will be described in detail based on the following figures, wherein:

FIG. 1 is an overall explanatory view of an image forming apparatus according to Example 1;

FIG. 2 is an explanatory view of an opened state of an opening/closing member in the printer according to Example 1;

FIG. 3 is a perspective view of the printer according to Example 1; and

FIG. 4 is an explanatory view of a printer according to a Example 2, which corresponds to FIG. 1 of Example 1.

### DETAILED DESCRIPTION

Next, the exemplary embodiments of the present invention will be described as specific examples with reference to the accompanying drawings. It should be noted that the present invention is not limited to the following exemplary embodiments.

In order to facilitate the easy understanding of the following description, in the drawings, the longitudinal direction is referred to as an X-axis direction, the transverse direction is referred to as an Y-axis direction, the vertical direction is referred to as a Z-axis direction, and the directions represented by or the sides represented by the arrows X, -X, Y, -Y, Z, and -Z are respectively referred to as the front direction, the rear direction, the right direction, the left direction, the upper direction, and the lower direction, or the front side, the rear side, the right side, the left side, the upper side, and the lower side.

In addition, in the drawings, the symbol in which “•” is written in “◯” means an arrow that points from the back to the front of the drawing sheet, and the symbol in which “×” is written in “◯” means an arrow that points from the front to the back of the drawing sheet.

In the following description using the drawings, for ease of understanding, illustrations other than members required for description will be appropriately omitted.

### EXAMPLE 1

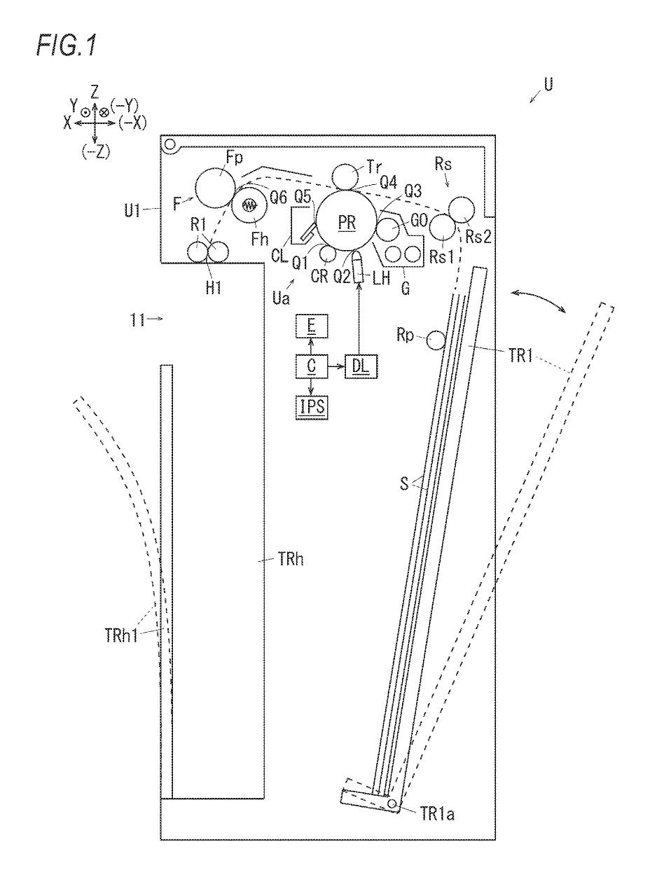

FIG. 1 is an overall explanatory view of an image forming apparatus according to Example 1.

In FIG. 1, in a printer U as an exemplary image forming apparatus according to Example 1 of the present invention, a discharge tray TRh as an exemplary media discharge unit is disposed in the front portion.

The printer U of Example 1 includes a controller C as an exemplary controller. The controller C is electrically connected to an image processing unit IPS, a laser drive circuit DL as an exemplary latent image forming circuit, and a power circuit E. Thus, the controller C may output a control signal to, for example, the image processing unit IPS.

A photoconductor PR as an exemplary image carrier is supported in the upper portion of the printer U. A charging roller CR, a latent image forming device LH, a developing device G, a transfer roller Tr as an exemplary transferring unit, and a photoconductor cleaner CL as an exemplary image carrier cleaner are arranged around the photoconductor PR in the rotational direction of the photoconductor PR.

The latent image forming device LH of Example 1 is configured with a device in which light emitting diodes (LEDs) as exemplary latent image recording elements are linearly arranged at a preset interval in the transverse direction, that is, a so-called LED head.

A developing roller Ga as an exemplary developer carrier is disposed opposite the photoconductor PR inside the developing device G.

In addition, in Example 1, the photoconductor PR or the charging roller CR, the developing device G, the latent image forming device LH, and the photoconductor cleaner Cl are formed into a unit and are configured to be integrally attachable to or detachable from the printer U and to be integrally replaceable.

In FIG. 1, a sheet feeding tray TR1 as an exemplary media accommodating unit is disposed in the rear portion of the printer U. The sheet feeding tray TR1 of Example 1 is downwardly inclined to the front side. Thus, the lower portion of the sheet feeding tray TR1 is disposed to be introduced to the lower side of the photoconductor PR. Therefore, the sheet feeding tray TR1 of Example 1 is configured such that sheets S as exemplary media may be accommodated upright in the gravity direction. The sheet feeding tray TR1 is supported to be movable about a rotation center TR1a at the lower end thereof between an accommodation position represented by the solid line in FIG. 1 and an opening position which is represented by the dashed line in FIG. 1. At the opening position, the sheet feeding tray TR1 has a smaller inclination angle than that at the accommodation position. Accordingly, in a state where the sheet feeding tray TR1 is moved to the opening position, the sheets S may be supplemented into the sheet feeding tray TR1 through an opening at the upper end portion of the sheet feeding tray TR1.

A pickup roller Rp as an exemplary medium pickup member is disposed at the front side of the sheet feeding tray TR1.

A separating roller Rs as an exemplary medium separating member is disposed above the pickup roller Rp. The separating roller Rs includes a feed roller Rs1 as an exemplary first delivery member that is an exemplary sheet feeding member, and a retard roller Rs2 which is an exemplary second delivery member and an exemplary separating member.

The pickup roller Rp and the separating roller Rs constitute a delivery unit Rp and Rs of Example 1.

A fixing device F is disposed in front of a transfer area Q4 in which the photoconductor PR and the transfer roller Tr are opposite each other. The fixing device F includes a lower side heating roller Fh as an exemplary heating fixing member, and an upper side pressure roller Fp as an exemplary pressure fixing member. A fixing area Q6 is formed by a contact area of a pair of the fixing rollers Fh and Fp.

A recording unit Ua of Example 1 is constituted of, for example, the photoconductor PR or the charging roller CR, the developing device G, the latent image forming device LH, the transfer roller Tr, the photoconductor cleaner CL, and the fixing device F.

A discharge roller R1 as an exemplary discharge member is disposed below the fixing device F.

A discharge port H1 as an exemplary opening is formed below the discharge roller R1.

The discharge tray TRh is disposed in the front portion of the printer U below the discharge port H1. The discharge tray TRh of Example 1 is supported by a sheet support plate TRh1 as an exemplary support member. The sheet support plate TRh1 has a plate shape whose lower end is fixed and supported and which extends upward. Accordingly, the discharge tray TRh extends in the gravity direction and is configured to accommodate the sheets S discharged from the discharge port H1 in a state where the sheets S are upright.

Accordingly, in the printer U of Example 1, the transport path of the sheets S from the sheet feeding tray TR1 to the discharge tray TRh through the transfer area Q4 has a substantially inverted U-shape.

### (Description of Image Forming Operation)

Printing information is transmitted from, for example, a computer as an exemplary external information transmission device, to the controller C of the printer U. When the controller C receives the printing information, an image forming operation is started. The controller C outputs the printing information to the image processing unit IPS. The image processing unit IPS converts the printing information to image information for latent image formation, thereby outputting the image information to the laser drive circuit DL as an exemplary image recording circuit at a preset time, that is, timing. The laser drive circuit DL outputs a drive signal to the latent image forming device LH according to the input image information.

When the image forming operation is started, the photoconductor PR starts to rotate.

A charging voltage is applied from the power circuit E to the charging roller CR. In a charging area Q1 in which the charging roller CR and the photoconductor PR are opposite each other, the charging roller CR charges the surface of the photoconductor PR.

The latent image forming device LH forms an electrostatic latent image on the surface of the photoconductor PR according to image information in a recording area Q2.

A developing voltage is applied from the power circuit E to the developing roller Ga of the developing device G. In a developing area Q3 in which the developing roller Ga and the photoconductor PR are opposite each other, the electrostatic latent image on the photoconductor PR is developed to a visible image using a developer on the developing roller Ga.

The pickup roller Rp delivers the sheets S accommodated in the sheet feeding tray TR1.

When the pickup roller Rp delivers plural sheets S, the separating roller Rs separates the sheets S one by one. The sheet S, which is separated one by one by the separating roller Rs, is transported to the transfer area Q4.

A transfer voltage is applied from the power circuit E to the transfer roller Tr. The transfer roller Tr transfers a toner image on the photoconductor PR to the sheet S that is passing through the transfer area Q4.

The photoconductor cleaner CL removes a toner remaining on the surface of the photoconductor PR in a cleaning area Q5 as an exemplary cleaning area that is set at the downstream side of the transfer area Q4.

In the transfer area Q4, the sheet S to which the toner image has been transferred is transported to the fixing device F in a state where the toner image is unfixed.

The fixing device F fixes the toner image on the surface of the sheet S transported to the fixing area Q6.

The discharge roller R1 discharges the sheet S to which the toner image has been fixed to the discharge tray TRh.

### (Opening/Closing Cover)

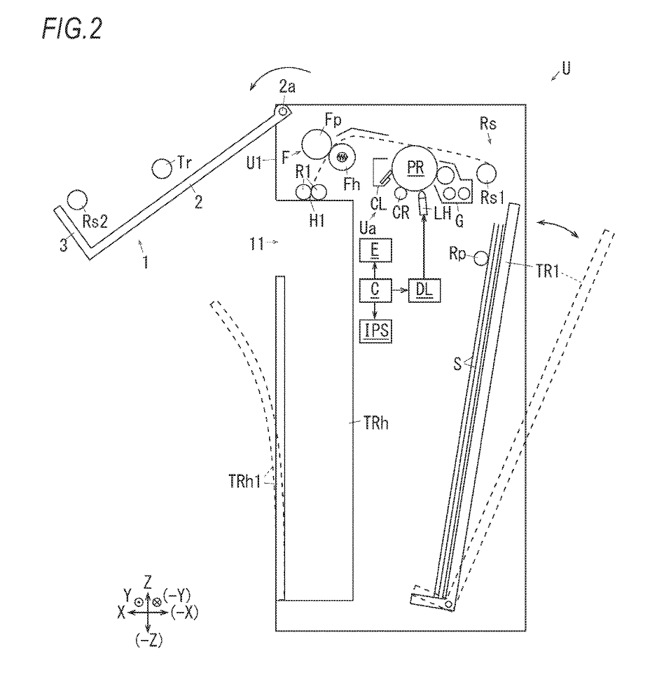

FIG. 2 is an explanatory view of an opened state of an opening/closing member in the printer according to Example 1.

In FIG. 2, in the printer U of Example 1, an opening/closing cover 1 as an exemplary opening/closing member is supported on the upper portion of a printer body U1 as an exemplary main body of the image forming apparatus. The opening/closing cover 1 of Example 1 includes a main body portion 2, which covers the entire upper surface of the printer body U1 in the longitudinal direction (that is, the direction that connects the sheet feeding tray TR1 side and the discharge tray TRh side to each other), and a rear wall portion 3, which extends downward from the rear end of the main body portion 2. The transfer roller Tr and the retard roller Rs2 are supported by the opening/closing cover 1 of Example 1.

The opening/closing cover 1 of Example 1 is rotatably supported on the printer body U1 about a rotation center 2a at the front end of the main body portion 2. Accordingly, the opening/closing cover 1 is movably supported between the closing position illustrated in FIG. 1 and the opening position illustrated in FIG. 2. The opening/closing cover 1 of Example 1 closes the upper surface of the printer body U1 at the closing position. In addition, at the opening position, the opening/closing cover 1 of Example 1 opens the upper portion of the printer body U1. Accordingly, at the opening position, a maintenance work of replacing a unit such as the photoconductor PR accommodated inside the printer body U1 or the fixing device F, or of removing the jammed sheet S is possible.

### (Discharge Tray)

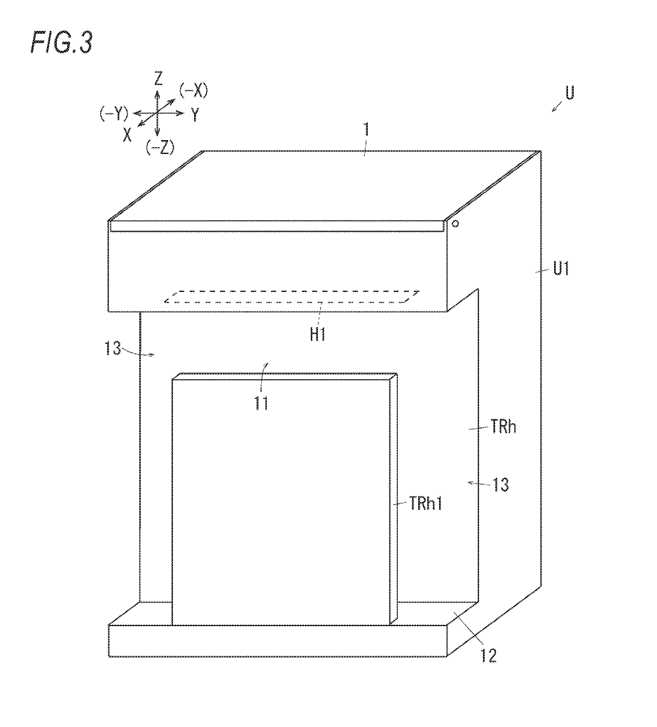

FIG. 3 is a perspective view of the printer according to Example 1.

In FIG. 3, in the discharge tray TRh of Example 1, a gap 11 as an exemplary open portion is formed between the upper end of the sheet support plate TRh1 and the discharge port H1. In addition, no sidewalls are installed at the left and right sides of the discharge tray TRh. Thus, at the left and right sides, a gap 13 as an exemplary open portion is formed in the entire vertical area between a bottom portion 12 and the discharge port H1.

In addition, the sheet support plate TRh1 of Example 1 is configured to be elastically deformable. Thus, when the amount of sheets S discharged to the discharge tray TRh is increased, the upper portion of the sheet support plate TRh1 is forwardly elastically deformable by the weight of a bundle of the sheets S. Accordingly, the discharge tray TRh of Example 1 is upwardly inclined to the front side when the amount of sheets S is increased. In other words, the discharge tray TRh of Example 1 is configured such that the sheets S are accommodated upright and are downwardly inclined to the rear side.

### (Function of Printer U)

In the printer U of Example 1 having the above-described configuration, when paper jam occurs or when, for example, the photoconductor PR, is replaced, the opening/closing cover 1 is moved to the opening position. When the opening/closing cover 1 is moved to the opening position, the transport path of the sheet S from the separating roller Rs to the fixing device F is opened. Thus, paper jam may be removed by simply opening the opening/closing cover 1.

In JP-A-07-334065, when paper jam occurs near a fixing device, the vicinity of the fixing device is not opened so long as a sheet feeding cassette 11 is not rotated. Thus, in order to enable a work of removing paper jam, an occupation area as large as the total length of a second support device 20, an apparatus body 1, and the sheet feeding cassette 11 in the horizontal state is required. Accordingly, upon an image forming operation, the occupation area of the sheet feeding cassette 11 may be narrow because the sheet feeding cassette 11 extends in the gravity direction. However, it is concerned that the actually required occupation area has such a size obtained by adding the maximum usable size of a sheet to this size.

In this connection, in Example 1, upon the removal of paper jam, paper jam from the separating roller Rs to the fixing device F may be removed by simply opening the opening/closing cover 1. Thus, it is not necessary to open the sheet feeding tray TR1. In particular, in Example 1, the longitudinal length of the printer body U1 may be, for example, 180 mm. The maximum size of the sheet S that can be used in the printer body U1 is A4. The printer body U1 is configured such that the sheet S is transported while the shorter side of the sheet S becomes a leading end. Accordingly, the length of the sheet feeding tray TR1 or the discharge tray TRh is set to 360 mm that includes a margin.

Further, in Example 1, the opening/closing cover 1 rotates forward when moving to the opening position. That is, the opening/closing cover 1 moves toward the side of the discharge tray TRh. The sheet S printed in the printer U is discharged to the discharge tray TRh, and a user discharges the sheet S from the side of the discharge tray TRh. That is, it is general that the space required for the user to access the printer U is normally secured at the side of the discharge tray TRh. Accordingly, there is little need to secure the space required to move the opening/closing cover 1 to the opening position.

In Example 1, the opening/closing cover 1 is opened by 180 degrees or more relative to the closing position. Alternatively, the opening angle may be below 180 degrees. Speaking from the viewpoint of removing paper jam in the recording unit Ua, the transport path from the entrance of the transfer area Q4 to the entrance of the fixing area Q6 (more preferably, the path from the exit of a transport roller (the separating roller Rs in Example 1) upstream of the transfer area Q4 to the entrance of the fixing area Q6) may be opened so as to be visible from at least directly above and be accessible. In addition, speaking from the viewpoint of the replacement of the recording unit Ua, the opening/closing cover 1 may be opened such that a replacement element, which is configured with (a portion of) the recording unit Ua such as the photoconductor PR, and is unitized, is visible from directly above and is dischargeable toward directly above.

Since there is no increase in occupation area due to the opening of the opening/closing cover 1 when the opening angle is 90 degrees or less, it is not necessary from the first to provide the space required to move the opening/closing cover 1 to the opening position at the front and rear of the printer U.

When the opening angle is 180 degrees or more, the inside of the printer body U1 is easily visible not only from directly above, but also from the more forwardly deviated direction than directly above. Even if the opening/closing cover 1 is opened by 180 degrees, an increase in occupation area is prevented compared to a case where the sheet feeding tray TR1 is opened until it becomes horizontal, based on a dimensional relationship between the longitudinal direction and the height direction of the printer body U1.

In addition, in the printer U of Example 1, the transfer roller Tr and the retard roller Rs2 are supported by the opening/closing cover 1. Thus, when the opening/closing cover 1 is moved to the opening position, the transfer roller Tr is spaced apart from the photoconductor PR, and the retard roller Rs2 is spaced apart from the feed roller Rs1. Accordingly, compared to a case where the transfer roller Tr or the retard roller Rs2 is not spaced apart from the photoconductor PR or the feed roller Rs1, a work of removing paper jam may be efficiently executed at the position of the transfer area Q4 or the separating roller Rs.

In particular, in Example 1, even if the retard roller Rs2 is spaced apart from the feed roller Rs1 and paper jam occurs above the sheet feeding tray TR1, the paper jam may be removed without opening or closing the sheet feeding tray TR1. No paper jam occurs below the sheet feeding tray TR1. In addition, even if paper jam occurs at the downstream side of the fixing device F, the paper jam may be removed from the discharge tray TRh side.

In addition, in the printer U of Example 1, the sheet feeding tray TR1 accommodates media such that the media are downwardly inclined in the gravity direction to the inner side, that is, the front side of the printer body U1. Thus, compared to a case where the sheet feeding tray TR1 is not inclined, the vertical height of the printer U may be reduced, and the size of the printer U may be reduced. In particular, in the printer U of Example 1, few members are disposed in the space below the photoconductor PR, and the space is empty. Accordingly, in the printer U of Example 1, the reduction in the size of the printer U is realized through the effective use of the space.

Further, in the printer U of Example 1, a relatively heavy member, such as the photoconductor PR, the developing device G, or the fixing device F, is deviated to the upper portion of the printer body U1. Thus, the position of the center of gravity of the entire printer U is raised. Accordingly, the printer U may be easily overturned when receiving external force. In this connection, in the printer U of Example 1, compared to a case where the sheet feeding tray is not inclined, the vertical height of the printer U is short and the position of the center of gravity is lowered. Accordingly, the overturn of the printer U is reduced.

In Example 1, the sheet feeding tray TR1 is supported to be movable between the accommodating position and the opening position about the rotation center TR1a at the lower end thereof. The sheet S may be supplemented in a state where the sheet feeding tray TR1 is at the opening position. It should be noted that the present invention is not limited thereto. For example, the sheet S may be supplemented from above the sheet feeding tray TR1 when the opening/closing cover 1 is opened by using the fact that the sheet feeding tray TR1 is not moved and the retard roller Rs2 retracts from the sheet feeding tray TR1 along with the opening/closing cover when the opening/closing cover 1 is opened.

In addition, in the printer U of Example 1, the discharge tray TRh is disposed below the discharge port H1. In addition, the discharge tray TRh of Example 1, as illustrated in FIG. 3, is opened at the gap 11 or at the left and right portions thereof. Thus, the discharge port H1 is continuously exposed to outside air. Thus, even if the temperature inside the printer body U1 is increased by heat of the fixing device F, cold outside air may be easily introduced through the discharge port H1. In particular, since the discharge port H1 is disposed below the fixing device F and the air heated in the fixing device F moves upward through, for example, the gap between the opening/closing cover 1 and the printer body U1, cold air may be easily introduced from the lower side.

Thus, in the printer U of Example 1, even if a sheet feeding tray 52 is not moved as in a configuration disclosed in JP-A-03-100672, the printer U may be cooled through the discharge port H1. In particular, in a configuration in which the sheet feeding tray 52 is moved to open a louver 68′ as disclosed in JP-A-03-100672, the occupation space is increased according to the movement of the sheet feeding tray 52. Accordingly, in Example 1, compared to the configuration disclosed in JP-A-03-100672, it is possible to prevent an increase in the temperature inside the printer U while reducing the occupation space.

In addition, in Example 1, as illustrated in FIG. 3, the gap 11 is formed over the entire area of the sheet S in the width direction. In addition, gaps, that is, spaces are formed at the left and right sides of the discharge tray TRh over the entire area of the sheet S in the transport direction. Thus, compared to a case where the gap 11 is formed in only a part of the width direction, the air may be easily introduced from the discharge port H1, and the sheet S maybe easily discharged from the discharge tray TRh.

Further, in Example 1, the sheet support plate TRh1 is configured to bend outward, that is, forward of the discharge tray TRh according to the weight of the sheet S. Thus, when the amount of sheets S discharged from the discharge tray TRh is increased, the gap 11 naturally becomes wide. Thus, compared to a case where the sheet support plate TRh1 is not bent, even if the amount of sheets S is increased, the efficiency with which outside air is introduced from the discharge port H1 may not be easily deteriorated, and the sheet S may be easily discharged through the widened gap 11.

### EXAMPLE 2

Next, Example 2 of the present invention will be described. In the description of Example 2, elements corresponding to the elements of Example 1 will be given the same reference numerals, and a detailed description thereof will be omitted.

This exemplary embodiment differs from Example 1 in the following terms, and the others are the same as those of Example 1.

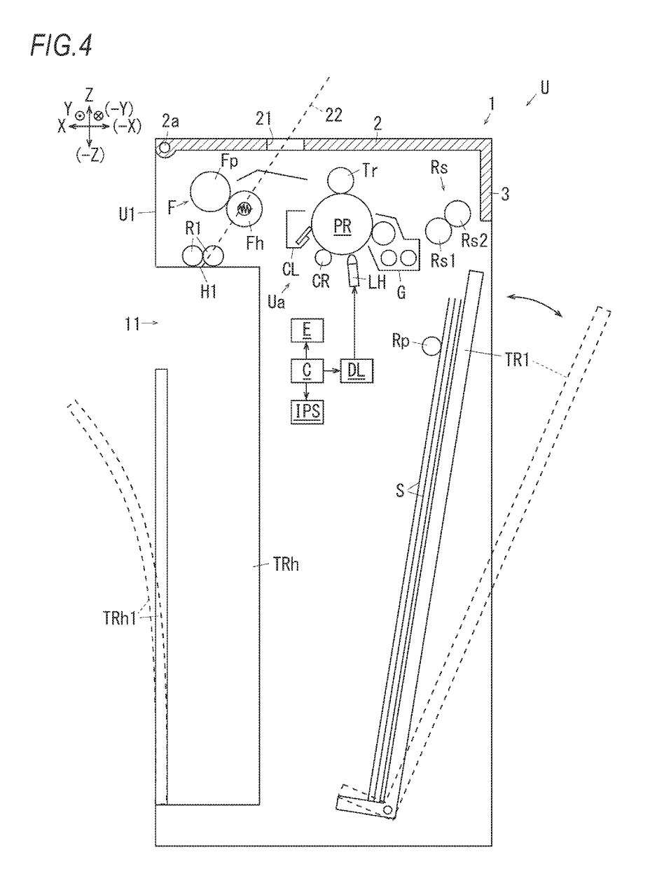

FIG. 4 is an explanatory view of a printer according to Example 2 of the present invention, which corresponds to FIG. 1 according to Example 1.

In FIG. 4, in the printer U of Example 2, the opening/closing cover 1 is provided with an upper opening 21.

The upper opening 21 of Example 2 is disposed on the extension of an imaginary line 22 that passes through the discharge port H1 and the heating roller Fh having a heat source.

### (Action of Example 2)

In the printer U of Example 2 having the above configuration, the discharge port H1, the heating roller Fh, and the upper opening 21 are disposed on the imaginary line 22. Thus, air heated by the heat source of the heating roller Fh is exhausted through the upper opening 21, and cold outside air is introduced from the discharge port H1 on the imaginary line 22. That is, the flow of air that passes through the heat source from the discharge port H1 toward the upper opening 21 may easily occur. Thus, compared to a case where the upper opening 21 is spaced apart from the imaginary line 22, cooling efficiency may be easily increased. Thus, an increase in the temperature inside of the printer U may be easily prevented.

### (Modification)

Examples of the present invention have been described above. It should be noted that the present invention is not limited to Examples described above. Various modifications may be performed within the range of the subject matter of the present invention disclosed in the scope of claims. Modifications H01to H010 of the present invention will be described below.
(H01) The printer U has been exemplified as an exemplary image forming apparatus in Examples described above. It should be noted that the present invention is not limited thereto. For example, the image forming apparatus may be configured with a copier, a fax machine, or a multifunction device having such a part or all of these functions. In addition, the present invention is not limited to an electrophotographic image forming apparatus, but may be applied to an image forming apparatus of an arbitrary recording type, such as an inkjet type or a thermal type (for example, a type using an ink ribbon or a type using a thermal-sensitive sheet).
(H02) The printer U uses a unicolor developer in Examples described above. It should be noted that the present invention is not limited thereto. For example, the printer may be applied to a multicolor image forming apparatus using two or more colors.
(H03) The dimensions exemplified in Examples described above maybe arbitrarily changed according to, for examples, designs or specifications.
(H04) The opening/closing cover 1 is configured to rotate about the rotation center 2a in Examples described above. It should be noted that the present invention is not limited thereto. The opening/closing cover 1 may be slidable, rather than being rotatable. In addition, the opening/closing cover 1 may rotate forward. Alternatively, the opening/closing cover 1 may rotate rearward. Further, for example, the opening/closing cover 1 may be configured such that a front half part rotates forward and a rear half part rotates rearward, that is, may be configured as a so-called clam-shell door. In addition, the opening position of the opening/closing cover 1 is illustrated in FIG. 2 as being at the position where the opening/closing cover 1 is rotated at a larger rotation angle than 180 degrees relative to the closing position. Alternatively, the opening position may be the position where the opening/closing cover 1 is rotated by 180 degrees or less.
(H05) The sheet feeding tray TR1 is configured to be downwardly inclined to the front side in Examples described above. It should be noted that the present invention is not limited thereto. The surface of the sheet feeding tray TR1, on which the sheet S is placed, may extend in the direction, the main component of which is the gravity direction, or may completely extend in the gravity direction. In addition, the rear surface of the discharge tray TRh extends in the gravity direction. It should be noted that the present invention is not limited thereto. The rear surface of the discharge tray TRh may extend in the direction, the main component of which is the gravity direction. For example, the rear surface of the discharge tray TRh may be downwardly inclined to the inner side, that is, the rear side of the printer body U1, or the discharge tray TRh may be inclined relative to the gravity direction. In this case, for example, the bottom surface of the discharge tray TRh may be downwardly inclined to the front side, thereby guiding the sheet S to the sheet support plate TRh1 side. Likewise, the sheet support plate TRh1 itself may be downwardly inclined to the rear side.
(H06) In the above described examples, the left and right sides of the discharge tray TRh may be opened over the entire vertical area. Alternatively, wall-shaped members may be disposed to cover the left and right sides partially or wholly. In addition, the gap 11 between the upper end of the sheet support plate TRh1 and the discharge port H1 may be formed over the entire transverse area. Alternatively, the gap 11 may be formed only in part of the transverse direction.
(H07) The transfer roller Tr and the retard roller Rs2 may be supported on the opening/closing cover 1 in Examples described above. Alternatively, the transfer roller Tr and the retard roller Rs2 may not be supported on the opening/closing cover 1. Conversely, for example, the pressure roller Fp or a guide member in the transport path may be supported on the opening/closing cover 1.
(H08) The opening/closing cover 1 has the rear wall portion 3 in Examples described above. It should be noted that the present invention is not limited thereto. The opening/closing cover 1 may not include the rear wall portion 3.
(H09) The position where the upper opening 21 is provided has been illustrated as being disposed based on the imaginary line 22 in Example 2. It should be noted that the present invention is not limited thereto. For example, a portion of the upper opening 21 or the entire upper opening 21 may be disposed to overlap a strip-shaped (band-shaped) area within a range of the width of the discharge port H1 or the width of the heating roller Fh, rather than overlapping a line.
(H010) In Examples described above, the sheet S as an exemplary media is not limited to paper. The sheet S may use an arbitrary medium, such as a resin film or a card, so long as the sheet S is a thin medium having a surface on which an image can be recorded.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a transferring unit that transfers an image carried on an image carrier to a medium;
a fixing unit that is disposed in an upper portion of a main body of the image forming apparatus, that includes a heat source, and that fixes the image transferred to the medium by heat;
a discharge port that is disposed below the fixing unit, the medium having the fixed image being discharged to the discharge port; and
a discharge unit that is disposed at a position where the discharge unit overlaps the fixing unit when viewed from above and below the fixing unit, that includes an open portion formed between the discharge unit and the discharge port, and that accommodates the medium having passed through the discharge port.

2. The image forming apparatus according to claim 1, wherein the open portion is formed over an entire area of the discharge unit in a width direction perpendicular to a discharge direction of the medium.

3. The image forming apparatus according to claim 1, wherein the open portion is formed over the entire area of the discharge unit in a discharge direction of the medium.

4. The image forming apparatus according to claim 2, wherein the open portion is formed over the entire area of the discharge unit in the discharge direction of the medium.

5. The image forming apparatus according to claim 1, wherein an upper opening is formed above the fixing unit.

6. The image forming apparatus according to claim 2, wherein an upper opening is formed above the fixing unit.

7. The image forming apparatus according to claim 3, wherein an upper opening is formed above the fixing unit.

8. The image forming apparatus according to claim 4, wherein an upper opening is formed above the fixing unit.

9. The image forming apparatus according to claim 5, wherein the upper opening is disposed on an extension of an imaginary line that passes through the discharge port and the fixing unit.

10. The image forming apparatus according to claim 6, wherein the upper opening is disposed on an extension of an imaginary line that passes through the discharge port and the fixing unit.

11. The image forming apparatus according to claim 7, wherein the upper opening is disposed on an extension of an imaginary line that passes through the discharge port and the fixing unit.

12. The image forming apparatus according to claim 8, wherein the upper opening is disposed on an extension of an imaginary line that passes through the discharge port and the fixing unit.
